(19) United States
(12) Patent Application Publication
(10) Pub. No.: US 2018/0310758 A1
(43) Pub. Date: Nov. 1, 2018

(54) PORTABLE LIQUID HEATING APPARATUS

(71) Applicant: Rolla R.W.T Ltd., Jerusalem (IL)

(72) Inventor: Raphael GABBAY, Jerusalem (IL)

(21) Appl. No.: 15/953,479

(22) Filed: Apr. 15, 2018

Related U.S. Application Data
(60) Provisional application No. 62/490,043, filed on Apr. 26, 2017.

(51) Int. Cl. A47J 36/24; A47J 36/32; A47J 41/00

(52) U.S. Cl. CPC A47J 36/2466; A47J 36/2483; A47J 2202/00; A47J 41/0055; A47J 36/32

(57) ABSTRACT

The present invention relates to the field of liquid heaters, and more specifically to portable devices for warming consumable liquids and for maintaining the elevated temperature of the liquid contained in a variety of liquid containers.

### FIELD OF THE INVENTION

The present invention relates to the field of liquid heaters, and more specifically to portable devices for boiling or warming consumable liquids within containers, and, optionally, for maintaining the liquids at elevated temperatures within the containers.

### BACKGROUND OF THE INVENTION

Beverages such as tea, coffee and the like may be consumed either indoors or outdoors. Due to increased time pressure and resurgence of outdoor activities, many users increasingly enjoy drinking outdoors. Preparation of a hot drink outdoors is challenging as it requires heating or boiling of the liquid, which usually requires an appropriate mobile power source. Moreover, even hot ready beverages tend to assume the ambient temperature in the environment into which they have been placed. For instance, a hot beverage, such as tea or coffee may quickly cool down when served in a conventional container such as a cup of a mug, rendering the beverage less enjoyable to the user. Current solution may offer beverage containers embedded with heating elements, which limit usability since the beverage can be consumed only from the drink container embedded with such elements. Solutions that are based on conventional immersion heaters, which include a heating element to be immersed in the liquid, pose a safety risk as they may cause burns if the user's skin comes in direct contact with such a heating element.

Vacuum flasks are usually designed to keep the warm temperature of the liquids contained therein for long periods of time. However, even vacuum flasks are usually limited to the range of a few hours. Moreover, vacuum flasks cannot reheat or boil cold liquids poured thereto or stored therewith.

There is an unmet need to portable heating devices, applicable to a wide variety of liquid containers, which are safe to use. In light of the above, it would be advantageous to provide heating devices which are portable, may be used with a wide variety of liquid containers, are configured for attachment to a wide variety of liquid containers, and are safe to use, meaning that minimize the burn risk to the user—either by the configuration of proper insulating components of the devices, specific configurations of attachment mechanisms to the liquid containers, or a combination of both.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other advantages or improvements.

In accordance with some embodiments, there are provided devices, assemblies and methods for heating liquids, including, but not limited to, beverages, which are portable, compact and can be used in conjunction with different types of liquid containers. While a portable liquid heating apparatus may pose a risk of exposing user's hands to the elevated temperatures of an integrated heating body, the disclosed technology advantageously reduces such risk by utilizing several features. One of the beneficial features of the technology disclosed herein is a heat-insulating sleeve, comprising heat-insulating materials which is formed to conform to the outer surface of a heating body of the heating apparatus disclosed herein. Another feature by which risk is reduced is the ability of the heating apparatus disclosed herein to be fixed to a liquid container such that heat is not accessible to user's hands during the operation of the heating apparatus.

As used herein, the term ‘fixed’ is interchangeable with any of the terms ‘fix’, ‘affixed’, ‘attached’ and the like, refers to being bound to or rigidly connected to.

In accordance with some embodiments, there is provided a portable liquid heating apparatus, the apparatus comprising a heating body having an outer peripheral surface, the heating body is configured to exert a plurality of operations, a heat-insulating sleeve configured to enclose said heating body, said heat-insulating sleeve comprises a plurality of apertures and a proximal end facing the handle and a handle connected to the heating body (the handle comprises a control circuitry configured to control the plurality of operations, at least one power source housing, configured to house at least one disposable power source, wherein the at least one disposable power source is configured to provide electrical energy to at least one of said control circuitry and said heating body and at least one internal switching mechanisms configured to activate or deactivate at least one operation of said plurality of operations.

In accordance with some embodiments, the heat-insulating sleeve is flexible.

In accordance with some embodiments, the heat-insulating sleeve comprises silicon.

In accordance with some embodiments, the apparatus further comprises at least one disposable power source housed within the at least one power source housings.

In accordance with some embodiments, the at least one disposable power source comprises a rechargeable power source.

In accordance with some embodiments, the handle further comprises a socket for a power charging cable, wherein said power charging cable is configured to supply power to said control circuitry.

In accordance with some embodiments, the apparatus further comprises at least one rechargeable power source, wherein said power charging cable is configured to recharge said at least one rechargeable power source.

In accordance with some embodiments, the socket comprises a USB charging port for a USB cable, wherein said USB is configured to supply power to said control circuitry.

In accordance with some embodiments, the handle further comprises a receiver unit, and wherein said receiver unit is configured to receive energy via an inductive magnetic field.

In accordance with some embodiments, the apparatus further comprises at least one disposable power source, wherein said at least one disposable power source is configured to be inductively charged by said receiver unit.

In accordance with some embodiments, the apparatus further comprises at least one solar cell, wherein said at least one solar cell is configured to collect solar energy and supply power to said control circuitry.

In accordance with some embodiments, the apparatus further comprises at least one rechargeable power source, wherein said at least one rechargeable power source is configured to be charged by said at least one solar cell.

In accordance with some embodiments, the apparatus further comprises at least one external switch, configured to control the at least one internal switching mechanisms.

In accordance with some embodiments, the handle is configured to wirelessly communicate with a remote electronic device thereby receiving commands to control the one or more internal switching mechanisms.

In accordance with some embodiments, the handle is configured to wirelessly receive vocal commands to control the one or more internal switching mechanisms.

In accordance with some embodiments, the handle is configured to wirelessly communicate with a remote electronic device, thereby transmitting information regarding the at least one operation of said plurality of operations.

In accordance with some embodiments, the handle further comprises at least one auditory element, configured to provide auditory signals corresponding to the at least one operation of said plurality of operations.

In accordance with some embodiments, the apparatus further comprises one or more temperature sensors, configured to measure the temperature of liquids surrounding said heating body.

In accordance with some embodiments, the at least one operation is heating.

In accordance with some embodiments, the apparatus further comprises a display element configured to display at least one of data corresponding to the at least one operation and data corresponding to the power source.

In accordance with some embodiments, the apparatus further comprises one or more temperature sensors, configured to measure the temperature of liquids surrounding said heating body, wherein the display element displays the temperature of the liquids.

In accordance with some embodiments, the at least one operation is heating liquid surrounding said heating body to a pre-set temperature value.

In accordance with some embodiments, the apparatus further comprises at least one switch, wherein the at least one switch is configured to receive from an operator a temperature value, said temperature value is the pre-set temperature value.

In accordance with some embodiments, the apparatus further comprises at least one liquid level sensor connected to said control circuitry such that said control circuitry is configured to deactivate the heating body when the at least one liquid level sensor senses liquid level below a predetermined threshold.

In accordance with some embodiments, the apparatus further comprises at least one liquid level sensor connected to said control circuitry such that said control circuitry is configured to deactivate the heating body when the at least one liquid level sensor senses liquid level below a predetermined threshold.

In accordance with some embodiments, the apparatus further comprises a timer, wherein the timer is configured to activate or deactivate at least one of said plurality of operations for predetermined time periods.

In accordance with some embodiments, the predetermined time periods comprise a first period of time and a second period of time, and wherein said timer is configured to deactivate the at least one of said plurality of operations during the first period of time and activate the at least one of said plurality of operations during the second period of time, in a recurring manner.

In accordance with some embodiments, the timer is configured to cease its operation when receiving a stopping signal.

In accordance with some embodiments, the stopping signal is transmitted wirelessly from an external device.

In accordance with some embodiments, the apparatus further comprises at least one gyro sensor, the gyro sensor is configured to sense angular orientation of said apparatus.

In accordance with some embodiments, the at least one of at least one of said plurality of operations is deactivated at specific angular orientations of said apparatus.

In accordance with some embodiments, the control circuitry is further configured to provide an indicator of a maximal expected liquid heating temperature, based on at least one of the following inputs: an expected outdoor duration, current measured power level of at least one disposable power source, current liquid temperature, current liquid level, and dimensions of liquid container.

In accordance with some embodiments, the apparatus further comprises a stopper extending from any one of the handle, the heat-insulating sleeve and the heating body, wherein said stopper is configured to prevent contact between the handle and liquid upon immersion of the liquid heating apparatus in the liquid.

In accordance with some embodiments, the stopper extends from the proximal end of the heat-insulating sleeve and is configured to prevent or reduce evaporation of liquid upon immersion of the apparatus within a container containing the liquid.

In accordance with some embodiments, the heat-insulating sleeve is reversibly attached to said heating body.

In accordance with some embodiments, the cross-section of said handle and the cross-section of said heating body are circular.

In accordance with some embodiments, there is provided a portable liquid heating apparatus, the apparatus comprising a heating module; and

a cap,

wherein the heating module comprises a heating body having an outer peripheral surface and a proximal portion, the heating body is configured to exert a plurality of operations; a top ring, having a ring inner screw thread and a ring electrically conductive portion; and an elongated extension extending from the proximal portion of the heating body to the top ring;

wherein the cap comprises a cap inner screw thread, a cap electrically conductive portion, a control circuitry configured to control the plurality of operations, at least one power source housing configured to house at least one disposable power source;

and wherein the at least one disposable power source is configured to provide electrical energy to at least one of said control circuitry and said heating body and at least one internal switching mechanisms configured to activate or deactivate at least one operation of said plurality of operations.

In accordance with some embodiments, the cap is configured to close an electrical circuit and conduct electricity to said heating body, through the top ring and elongated extension, when the cap electrically conductive portion is in contact with the ring electrically conductive portion.

In accordance with some embodiments, the ring inner screw thread is configured to be screwed onto an annular body having a first complementary outer screw thread.

In accordance with some embodiments, the cap inner screw thread is configured to be screwed onto an annular body having a second complementary outer screw thread.

In accordance with some embodiments, the diameter of said ring inner screw thread is smaller than the diameter of said cap inner screw thread.

In accordance with some embodiments, the top ring further comprises a ring outer screw thread, and wherein said cap inner screw thread is configured to be screwed onto the ring outer screw thread.

In accordance with some embodiments, the elongated extension comprises at least one extension arm.

In accordance with some embodiments, the elongated extension comprises a cylindrical cross-section, said cylindrical elongated extension comprises at least one aperture through which liquid may flow.

In accordance with some embodiments, the at least one internal switching mechanism is configured to automatically activate the at least one operation when the cap electrically conductive portion is in contact with the ring electrically conductive portion.

In accordance with some embodiments, the apparatus further comprises at least one external switch, configured to control the at least one internal switching mechanisms.

In accordance with some embodiments, the cap is configured to wirelessly communicate with a remote electronic device thereby receiving commands to control the one or more internal switching mechanisms.

In accordance with some embodiments, the handle is configured to wirelessly receive vocal commands to control the one or more internal switching mechanisms.

In accordance with some embodiments, the cap is configured to wirelessly communicate with a remote electronic device, thereby transmitting information regarding the at least one operation of said plurality of operations.

In accordance with some embodiments, the cap further comprises at least one auditory element, configured to provide auditory signals corresponding to the at least one operation of said plurality of operations.

In accordance with some embodiments, the apparatus further comprises at least one disposable power source housed within the at least one power source housings.

In accordance with some embodiments, the at least one disposable power source comprises a rechargeable power source.

In accordance with some embodiments, the cap further comprises a socket for a power charging cable, wherein said power charging cable is configured to supply power to said control circuitry.

In accordance with some embodiments, the apparatus further comprises at least one rechargeable power source, wherein said power charging cable is configured to recharge said at least one rechargeable power source.

In accordance with some embodiments, the socket comprises a USB charging port for a USB cable, wherein said USB is configured to supply power to said control circuitry.

In accordance with some embodiments, the handle further comprises a receiver unit, and wherein said receiver unit is configured to receive energy via an inductive magnetic field.

In accordance with some embodiments, the apparatus further comprises at least one disposable power source, wherein said at least one disposable power source is configured to be inductively charged by said receiver unit.

In accordance with some embodiments, the apparatus further comprises at least one solar cell, wherein said at least one solar cell is configured to collect solar energy and supply power to said control circuitry.

In accordance with some embodiments, the apparatus further comprises at least one rechargeable power source, wherein said at least one rechargeable power source is configured to be charged by said at least one solar cell.

In accordance with some embodiments, the apparatus further comprises one or more temperature sensors, configured to measure the temperature of liquids surrounding said heating body.

In accordance with some embodiments, the at least one operation is heating.

In accordance with some embodiments, the apparatus further comprises a display element configured to display at least one of data corresponding to the at least one operation and data corresponding to the power source.

In accordance with some embodiments, the apparatus further comprises one or more temperature sensors, configured to measure the temperature of liquids surrounding said heating body wherein the display element displays the temperature of the liquids.

In accordance with some embodiments, the at least one operation is heating liquid surrounding said heating body to a pre-set temperature value.

In accordance with some embodiments, the apparatus further comprises at least one liquid level sensor connected to said control circuitry such that said control circuitry is configured to deactivate the heating body when the at least one liquid level sensor senses liquid level below a predetermined threshold.

In accordance with some embodiments, the apparatus further comprises a timer, wherein the timer is configured to activate or deactivate at least one of said plurality of operations for predetermined time periods.

In accordance with some embodiments, the predetermined time periods comprise a first period of time and a second period of time, and wherein said timer is configured to deactivate the at least one of said plurality of operations during the first period of time and activate the at least one of said plurality of operations during the second period of time, in a recurring manner.

In accordance with some embodiments, the timer is configured to cease its operation when receiving a stopping signal.

In accordance with some embodiments, the stopping signal is transmitted wirelessly from an external device.

In accordance with some embodiments, the apparatus further comprises at least one gyro sensor, the gyro sensor is configured to sense angular orientation of said apparatus.

In accordance with some embodiments, the at least one of at least one of said plurality of operations is deactivated at specific angular orientations of said apparatus.

In accordance with some embodiments, the apparatus further comprises a pressure relief safety valve, the pressure relief safety valve is configured to provide automatic release of pressure when said pressure rises above a predefined threshold.

In accordance with some embodiments, the apparatus further comprises a cap-locking mechanism, the cap-locking mechanism is configured to lock said cap to said heating module.

In accordance with some embodiments, the apparatus further comprises a lock-controlling electrical circuitry, the lock-controlling electrical circuitry is configured to control the operation of said cap-locking mechanism.

In accordance with some embodiments, the apparatus further comprises at least one gyro sensor, the gyro sensor is configured to sense angular orientation of said apparatus, wherein the lock-controlling electrical circuitry is configured to lock or unlock the cap-locking mechanism at specific angular orientations of said apparatus.

In accordance with some embodiments, the control circuitry is further configured to provide an indicator of a maximal expected liquid heating temperature, based on at least one of the following inputs: an expected outdoor duration, current measured power level of at least one disposable power source, current liquid temperature, current liquid level, and dimensions of liquid container.

In accordance with some embodiments, the apparatus further comprises a heat-insulating sleeve configured to enclose said heating body, said heat-insulating sleeve comprises a plurality of apertures.

In accordance with some embodiments, the heat-insulating sleeve is flexible.

In accordance with some embodiments, the heat-insulating sleeve comprises silicon.

In accordance with some embodiments, the heat-insulating sleeve is configured to further enclose the elongated extension.

In accordance with some embodiments, the heat-insulating sleeve is reversibly attached to said heating body.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1a constitutes a perspective view of a portable liquid heating apparatus, from a top-side angle, in accordance with some embodiments;

FIG. 1b constitutes a perspective view of a portable liquid heating apparatus, from a down-side angle, in accordance with some embodiments;

FIG. 2a constitutes a full-blown view of a portable liquid heating apparatus, in accordance with some embodiments;

FIG. 2b constitutes a full-blown side view of a portable liquid heating apparatus, in accordance with some embodiments.

FIG. 3 constitutes a cross-sectional view of a portable liquid heating apparatus, in accordance with some embodiments.

FIG. 4a constitutes a view in perspective of a heat-insulating sleeve, from a down-side angle, in accordance with some embodiments.

FIG. 4b constitutes a perspective view of a heat-insulating sleeve, from a top-side angle, in accordance with some embodiments.

FIG. 5 constitutes a perspective view of a portable liquid heating apparatus, attached to a vacuum flask, in accordance with some embodiments.

FIG. 6a constitutes a full-blown cross-sectional view of a portable liquid heating apparatus, adapted for a vacuum flask, in accordance with some embodiments.

FIG. 6b constitutes a full-blown view in perspective of a portable liquid heating apparatus, adapted for a vacuum flask, in accordance with some embodiments.

FIG. 7 constitutes a cross-sectional view of the apparatus of FIG. 5.

FIG. 8a constitutes a perspective view of a heating module, in accordance with further embodiments.

FIG. 8b constitutes a cross-sectional view of a heating module, in accordance with further embodiments.

FIG. 9a constitutes a full-blown view of a portable liquid heating apparatus, adapted for a vacuum flask, in accordance with some embodiments.

FIG. 9b constitutes a full-blown cross-sectional side view of a portable liquid heating apparatus, adapted for a vacuum flask, in accordance with some embodiments.

FIG. 10 constitutes a cross-sectional view of the apparatus of FIGS. 9a-9b.

FIG. 11a constitutes a perspective view of a heating module, in accordance with further embodiments.

FIG. 11b constitutes a cross-sectional view of a heating module, in accordance with further embodiments.

FIG. 12a constitutes a full-blown view of a portable liquid heating apparatus, adapted for a travel mug, in accordance with some embodiments.

FIG. 12b constitutes a full-blown cross-sectional side view of a portable liquid heating apparatus, adapted for a travel mug, in accordance with some embodiments.

FIG. 13 constitutes a cross-sectional view of the apparatus of FIGS. 12a-12b.

### DETAILED DESCRIPTION OF SOME EMBODIMENTS

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure. In the figures, like reference numerals refer to like parts throughout.

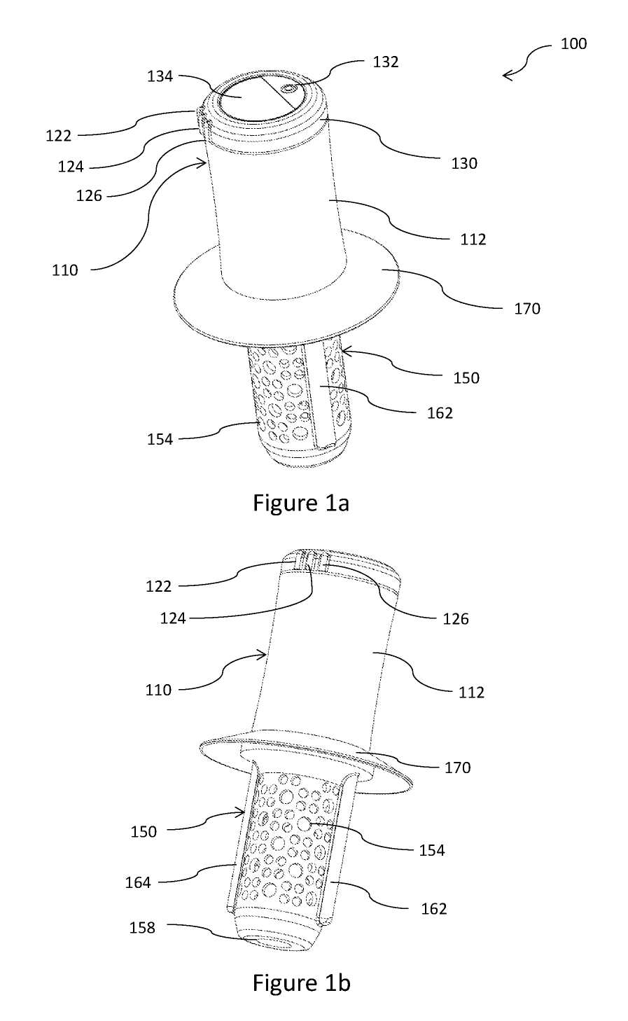

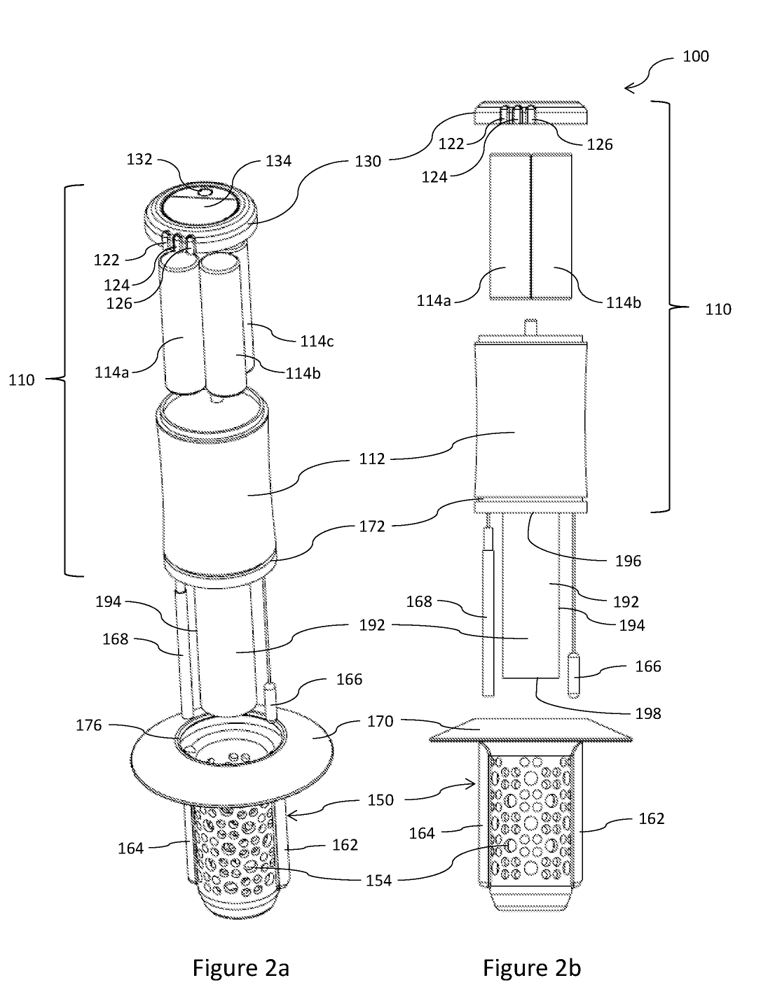

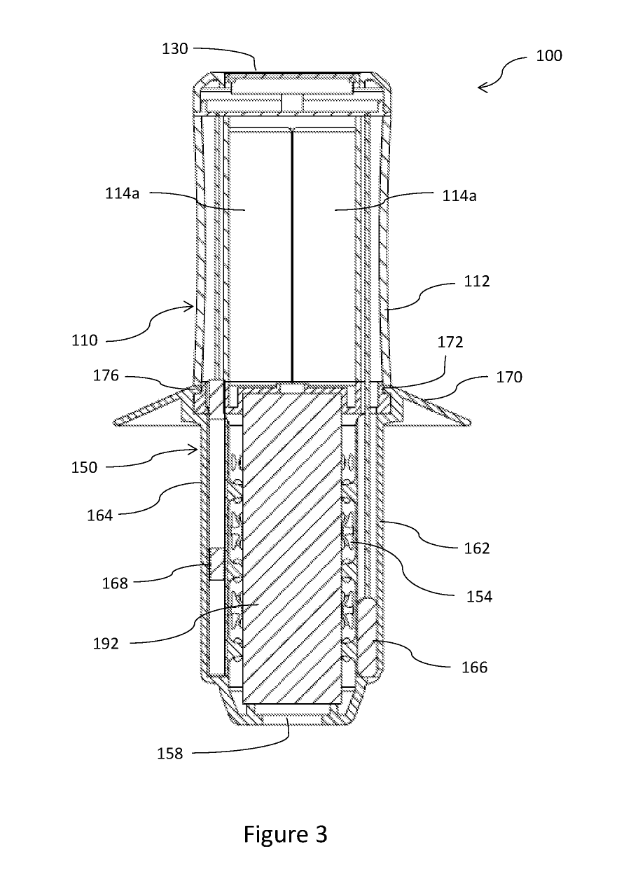

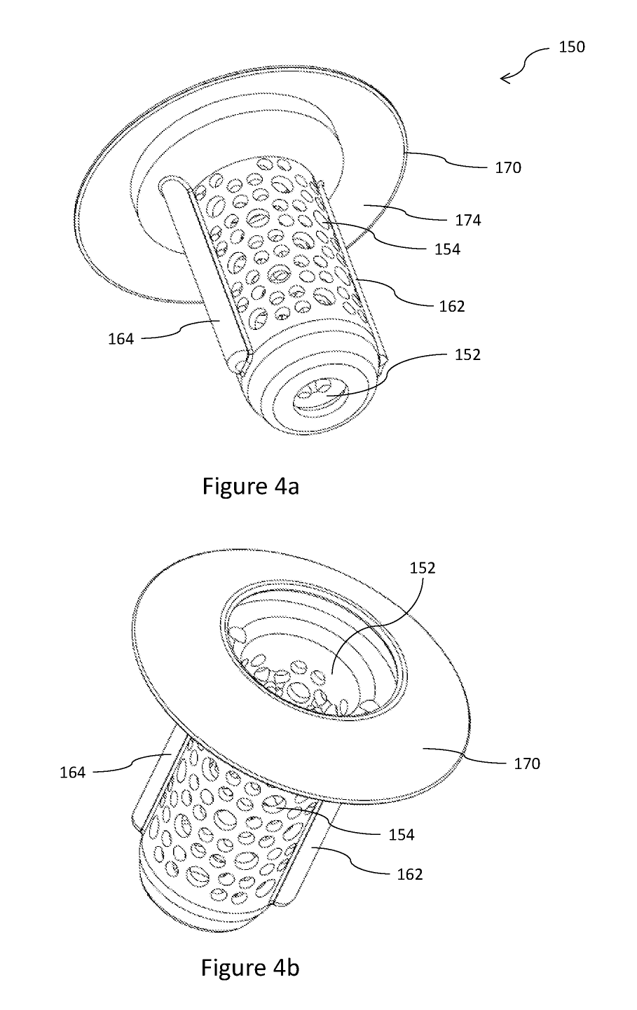

Reference is now made to FIGS. 1a-4b. FIGS. 1a and 1b constitute views in perspective of a portable liquid heating apparatus 100, from a top-side angle and from a bottom-side angle, respectively, in accordance with some embodiments. FIGS. 2a and 2b constitute a full-blown perspective and side views, respectively, of the portable liquid heating apparatus 100. FIG. 3 constitutes a cross-sectional view of the portable liquid heating apparatus 100. The portable liquid heating apparatus 100 comprises heating body 192, a handle 110, and heat-insulating sleeve 150. FIGS. 4a and 4b constitute views in perspective of a heat-insulating sleeve, from a down-side angle and from a top-side angle, respectively, in accordance with some embodiments.

Heating body 192 comprises heating body outer peripheral surface 194, having two ends: a proximal end 196 and distal end 198. Handle 110 comprises handle cover 130 having top surface 134, handle body 112, at least one power source housing (not numbered) and a control circuitry (not shown).

In accordance with some embodiments, heating body 192 is configured to be either partially or fully immersed within a liquid container. In accordance with some embodiments, the liquid is a beverage, such as, coffee, tea, chocolate drink, water and soup, and the liquid container is a beverage container, such as, a cup, a mug, a glass, a vacuum flask, a bowl, a pot and a jar. The length of heating body 192 is preferably chosen to correspond to the depth of the liquid container. In accordance with some embodiments, the length of heating body 192 is equal to or smaller than the depth of the liquid container.

In accordance with some embodiments, a control circuitry is operably associated with heating body 192 for supplying power to heating body 192, either for electively heating the liquid, in which heating body 192 is immersed, to a selected temperature, or for regulating the heating of heating body 192 to maintain the liquid at a selected temperature.

In accordance with some embodiments, the at least one power source housing is configured to house at least one power source. In accordance with some embodiments, the at least one power source is a disposable power source.

In accordance with some embodiments, the at least one disposable power source is a rechargeable power source (see rechargeable power sources 114a-c in FIG. 2a, wherein rechargeable power source 114d is hidden from view). It will be clear that any reference to a disposable rechargeable power source throughout the specification, may also relate to a permanent rechargeable power source.

In accordance with some embodiments, portable liquid heating apparatus 100 further comprises a receiver unit (not shown) configured for receiving energy from an external base unit (not shown) via an inductive magnetic field, wherein the at least one rechargeable power source is capable of being inductively powered and/or charged by the receiver unit.

As used herein, the term “energy” refers to electrical energy such as electricity or power. Energy is quantified in e.g. Watt-hour, Ampere-hour, or Joule.

In accordance with some embodiments, handle cover 130 further comprises socket 132 for a power charging cable (not shown). The power charging cable, when connected to socket 132 and electrically connected to an external power source (not shown), is configured to either supply power to recharge the at least one rechargeable power source 114a-d, to supply power directly to the control circuitry and heating body 192, or both.

In accordance with some embodiments, socket 132 comprises a USB charging port configured for receiving a USB cable (not shown). The USB cable, when connected to the USB charging port, serves as a power charging cable in a similar manner described hereinabove.

In accordance with some embodiments, handle cover 130 further comprises an outgoing socket (not shown), configured to connect to a charging cable to transmit power from the at least one disposable power source to an external device thereby charging said external device. In accordance with some embodiments, the external device includes, but is not limited to, a mobile phone, a mobile watch, a tablet or a laptop. In accordance with some embodiments, the outgoing socket comprises a USB outgoing port configured for receiving a USB cable (not shown). The USB cable, when connected to the USB outgoing port, serves as a charging cable configured to transmit power to the external device.

In accordance with some embodiments, the portable liquid heating apparatus 100 further comprises at least one solar cell or solar panel (not shown), configured to collect solar energy that can be used to supply power for recharging the at least one rechargeable power source 114a-d, to supply power directly to the control circuitry and heating body 192, or both.

In accordance with some embodiments, portable liquid heating apparatus 100 is a mobile device. In accordance with some embodiments, portable liquid heating apparatus 100 is a mobile device having a compact size which enhances its portability and discreet operation. In accordance with some embodiments, an operator can carry portable liquid heating apparatus 100 and use it for heating liquids contained in any liquid containers, such as those described hereinabove. In accordance with some embodiments, portable liquid heating apparatus 100 can be used by an operator at any location, indoors or outdoors.

As used herein, the terms “liquid” and “liquids” are interchangeable.

Further advantage of portable liquid heating apparatus 100 is that it can be used to heat several similar or dissimilar liquid containers consecutively, in accordance with some embodiments. In accordance with some embodiments, there is provided a method of using portable liquid heating apparatus 100 in a plurality of containers, the method comprising the steps of: immersing and operating apparatus 100 within a first liquid container, thereby heating the liquid within the first liquid container to a pre-set temperature; removing apparatus 100 from the first liquid container; and immersing and operating apparatus 100 in a second, similar or dissimilar liquid container, thereby heating the liquid within the second liquid container to the pre-set temperature or to a different pre-set temperature. The above mentioned mode of operation can be repeated in additional liquid containers as long as the liquid containers conform to the size of apparatus 100, and as long as apparatus 100 is supplied with sufficient power to operate the control circuitry and heating element 192.

In accordance with some embodiments, the control circuitry is equipped with an internal switching mechanism (not shown), which is configured to turn on or off power transfer to heating body 192. In accordance with some embodiments, handle cover 130 further comprises an external On/Off switch 122, configured to operate the internal switching mechanism.

In accordance with some embodiments, handle cover 130 further comprises temperature increase switch 124 and temperature decrease switch 126, configured to allow an operator of apparatus 100 to select or adjust a pre-set temperature for the liquid, thereby controlling the temperature that heating body 192 should reach and/or maintain. In accordance with some embodiments, temperature increase switch 124 and temperature decrease switch 126 are external switches configured to operate the internal switching mechanism, either directly or according to consequent information processing by the control circuitry.

In accordance with some embodiments, the pre-set temperature may vary only in a predetermined range of values, such that the operator will not be able to reduce the desired temperature value below a predetermined minimal temperature, and will not be able to increase the pre-set temperature value above a predetermined maximal temperature. In accordance with some embodiments, the predetermined range of values is between 30 and 100 degrees Celsius. In accordance with some embodiments, the predetermined range of values is between 40 and 99 degrees Celsius.

In accordance with some embodiments, handle cover 130 further comprises a display (not shown) at top surface 134 or side surface of handle body 112, configured to display data corresponding to either the operation of the control circuitry, and/or the status of the at least one rechargeable power sources 114a-d. In accordance with some embodiments, the display comprises an LCD screen, or any other type of display screen obvious to a skilled person for displaying numerical figures, textual messages and symbols or icons in digital format.

In accordance with some embodiments, the control circuitry is configured to wirelessly communicate with remote electronic devices, thereby transmitting information regarding the operation of the control circuitry.

In accordance with some embodiments, handle 110 further comprises an auditory signal generator unit, such as a speaker, configured to generate sound pulses, beeps, tunes or vocal messages to alert the operator when the temperature of the liquid reaches the pre-set temperature value.

In accordance with some embodiments, external On/Off switch 122, temperature increase switch 124, temperature decrease switch 126, or any combination thereof comprise any one or more of knobs, switches, dials, levers, buttons and touch interfaces.

In accordance with some embodiments, internal switching mechanism is configured to wirelessly communicate with remote electronic devices, thereby receiving external signals or vocal commands to control the internal switching mechanism. In accordance with some embodiments, switches 122, 124, 126 and the display are located on handle cover 130. However, it should be understood, based on this disclosure, that the location of either one of switches 122, 124, 126 or the display can be at any other location of the handle.

The control circuitry is configured to control a plurality of operations, including but not limited to power transfer from either power sources 114a-d or the power supply cable attached to socket 132, to heating body 192, and regulation of the amount of such power transfer, thereby regulating the heat output from heating body 192 to the surrounding liquid in its vicinity.

In accordance with some embodiments, switching On/Off switch 122 to On state is a mandatory, but not necessarily sufficient, condition for the control circuitry to allow power supply or regulate the amount of power supplied to heating body 192, thereby activating it. Switching On/Off switch 122 to Off state is a mandatory and sufficient condition for the control circuitry to stop or prevent initiation of the power supply to heating body 192, thereby deactivating it.

In accordance with some embodiments, internal switching mechanism may further comprise a timer (not shown), configured to activate or deactivate on or more operations, such as, but not limited to, the operation of: the heating body, the display, the auditory signal generator unit, switches 122, 124, 126, incoming and outgoing wireless signal transmission, or any combination thereof. In accordance with some embodiments, the timer activates or deactivates the aforementioned operations for predefined time periods, wherein the time periods can be recurring time periods. In accordance with some embodiments, the timer allows periodic power transfer, thereby defining a cycle composed of a first period of time and a second period of time. In the course of each cycle, activation of an operation is allowed during the first period of time and deactivated during the second period of time, said cycle continues in a loop for either one of: a predefined amount of cycles, a predefined operation duration, or a stop signal. In accordance with some embodiments, the timer is configured to cease its operation when receiving a stop signal. In accordance with some embodiments, the stop signal is transmitted from an external device via wireless communication. In accordance with some embodiments, the timer comprises a spring-operated mechanical mechanism, an electrical timing mechanism or any other mechanism known in the art.

In accordance with some embodiments, temperature sensor 166, which is electrically connected to the control circuitry, is configured to measure the temperature of the liquid surrounding heating body 192. Temperature sensor 166 may comprise any one or more of a thermistor, a thermometer, and an IR sensor.

In accordance with some embodiments, a plurality of temperature sensors 166 are located at different levels along heating body 192 to provide data regarding liquid temperature at different height levels within the liquid container.

In accordance with some embodiments, the pre-set temperature level set by usage of temperature increase switch 124 and temperature decrease switch 126 is compared in real-time to the liquid temperature as measured by either single temperature sensor 166 or an averaged value from the measurements of multiple such temperature sensors, so that a measured temperature which is lower than the pre-set temperature is a mandatory, but not necessarily sufficient, condition for the control circuitry to allow power supply or regulate the amount of power supplied to heating body 192. A measured temperature which is equal to or higher than the pre-set temperature is a mandatory and sufficient condition for the control circuitry to stop or prevent initiation of the power supply to heating body 192, thereby deactivating it.

In accordance with some embodiments, liquid-level sensor 168, which is electrically connected to the control circuitry, is configured to measure the level of the liquid surrounding heating body 192.

In accordance with some embodiments, the liquid level measured by liquid-level sensor 168 is compared to a predetermined minimum level threshold, such that a measured liquid level above the predetermined minimum level threshold is a mandatory, but not necessarily sufficient, condition for the control circuitry to allow power supply to heating body 192. In accordance with some embodiments, a measured liquid level, which is equal to or lower than the predetermined minimum level threshold, is a mandatory and sufficient condition for the control circuitry to stop or prevent initiation of the power supply to heating body 192, thereby deactivating it.

In accordance with some embodiments, the control circuitry further comprises at least one gyro sensor (not shown), configured to sense angular orientation of the portable liquid heating apparatus 100, such as, but not limited to, horizontal or vertical orientations. In accordance with some embodiments, the control circuitry is configured to control a plurality of operations. In accordance with some embodiments, at least one of the plurality of operations including heating by the heating body, is deactivated in certain predetermined orientations, such as a horizontal of a vertical “upside-down” orientation.

In accordance with some embodiments, the control circuitry is further configured to execute an algorithm based on at least one input supplied by the operator and at least one input measured by the sensors of the apparatus 100. Inputs supplied by the operator include, but are not limited to, expected outdoor duration (e.g. through communication means embedded on the apparatus, or wireless data transmission from an external device). Inputs measured by the sensors of the apparatus 100 include, but are not limited to: current power level of the at least one disposable power source, current liquid temperature, and current liquid level (which, combined with predetermined or entered data regarding container dimensions, can provide dimensions of fluid volume). In accordance with some embodiments, the output of the algorithm is an indicator of the expected liquid heating temperature, either as an absolute value or as a function of time. In accordance with some embodiments, the output is displayed on the display of the apparatus, or transmitted wirelessly to an external device (e.g. a mobile phone).

In accordance with some embodiments, heat-insulating sleeve 150 is made of materials with very low thermal conductivity. In accordance with some embodiments, the thermal insulation properties of heat-insulating sleeve 150 ensure that heated heating body 192, as well as heated liquid surrounding said sleeve, do not result in heating heat-insulating sleeve 150 to a temperature higher than ambient or room temperature. In accordance with some embodiments, heat-insulating sleeve 150 comprises a flexible heat-insulating material. In accordance with some embodiments, heat-insulating sleeve 150 is flexible. In accordance with some embodiments, heat-insulating sleeve 150 comprises silicon. In accordance with some embodiments, heat-insulating sleeve 150 consists silicon.

In accordance with some embodiments, heat-insulating sleeve 150, having an inner sleeve surface 152, is formed to conform to the outer surface of heating body 192, such that inner sleeve surface 152 is in contact with heating body outer peripheral surface 194, while conforming simultaneously the shape of any other elements attached to heating body 192, such as sensors.

In accordance with some embodiments, heat-insulating sleeve 150 further comprises at least one sensor compartments, such as first sensor compartment 162 and second sensor compartment 164. In accordance with some embodiments, the at least one sensor compartment 162, 164 is formed as a tube, dimensioned to accommodate a sensor therein. In accordance with some embodiments, heat-insulating sleeve 150 further comprises terminals (not shown) for wires connecting sensors housed within sensor compartments to the control circuitry. In accordance with some embodiments, heat-insulating sleeve 150 further comprises silicon terminals (not shown) for wires connecting sensors housed within sensor compartments to the control circuitry.

In accordance with some embodiments, the one or more temperature sensors 166 are housed in first sensor compartment 162.

In accordance with some embodiments, liquid-level sensor 168 is housed in second sensor compartment 164.

In accordance with some embodiments, heat-insulating sleeve 150 further comprises a plurality of apertures 154, configured to allow liquid to be in direct contact with heating body 192, yet configured to prevent direct contact of any human organ, with heating body 192. This configuration is advantageous for preventing the majority of heat generated by heating body 192 from being reachable to an operator's hand, while not compromising the main function of apparatus 100, namely conducting direct heat to the surrounding liquid.

In accordance with some embodiments, heat-insulating sleeve 150 further comprises an opening at the distal edge (not numbered), so as to allow direct contact between a portion of heating body distal end 198 and the liquid.

In accordance with some embodiments, heat-insulating sleeve 150 further comprises stopper 170, extending radially outwards from the proximal end of the heat-insulating sleeve (not numbered). In accordance with some embodiments, stopper 170 further comprises internal ridge 176, configured to be placed within a distal concentric depression 172 in order to allow attachment of stopper 170 to handle 110.

In accordance with some embodiments, stopper 170 is extending directly from the distal concentric depression 172 of the handle 110, without being attached to heat-insulating sleeve 150.

In accordance with some embodiments, stopper 170 is extending directly from the heating body 192, without being attached to any of heat-insulating sleeve 150 and handle 110.

In accordance with some embodiments, stopper 170 is configured to extend beyond the rim of a liquid container (not shown), such that when portable liquid heating apparatus 100 is placed in position on the liquid container, the downwardly facing surface of stopper 174 (see FIG. 4a) is located on the rim of the liquid container, preventing handle 110 from being in contact with the liquid.

In accordance with some embodiments, stopper 170 is made of materials with very low thermal conductivity, such as silicon.

An advantage of stopper 170 of the disclosed technology is that while placing apparatus 100 on top of the rim of a liquid container, stopper 170 prevents handle 110 from being in contact with the liquid inside the container. Further benefit of stopper 170 is that it may reduce vapor loss from the heated liquid.

In accordance with some embodiments, stopper 170 contains at least one aperture (not shown), configured to allow vapor release to the environment, thereby reducing risk of high pressure buildup in case the pre-set temperature is around or at the boiling temperature of the liquid within the container.

In accordance with some embodiments, portable liquid heating apparatus 100 further comprises a screw thread region (not shown), adapted to match a complementary screw thread of a container. In accordance with some embodiments, screw thread region is located on handle 110. In accordance with some embodiments, screw thread region is located on handle cover 130. In accordance with some embodiments, screw thread region is located on handle body 112. In accordance with some embodiments, screw thread region is located on heat-insulating sleeve 150. In accordance with some embodiments, screw thread region is located adjacent stopper 170.

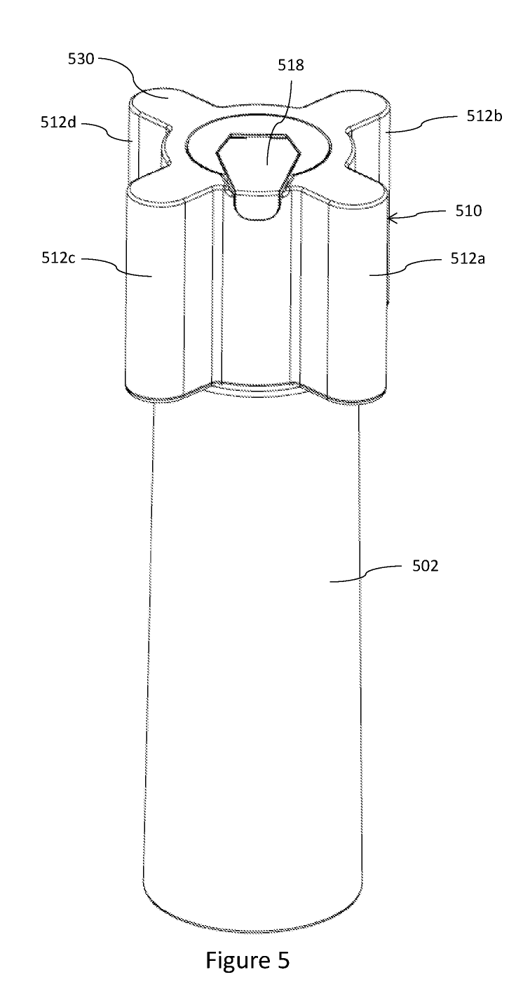

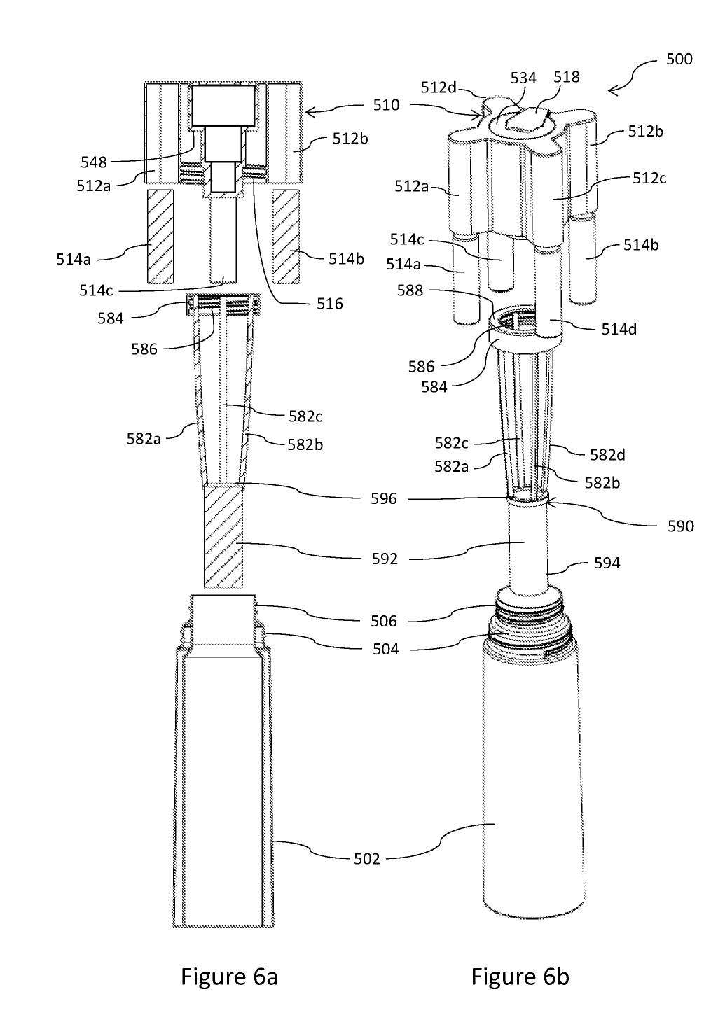

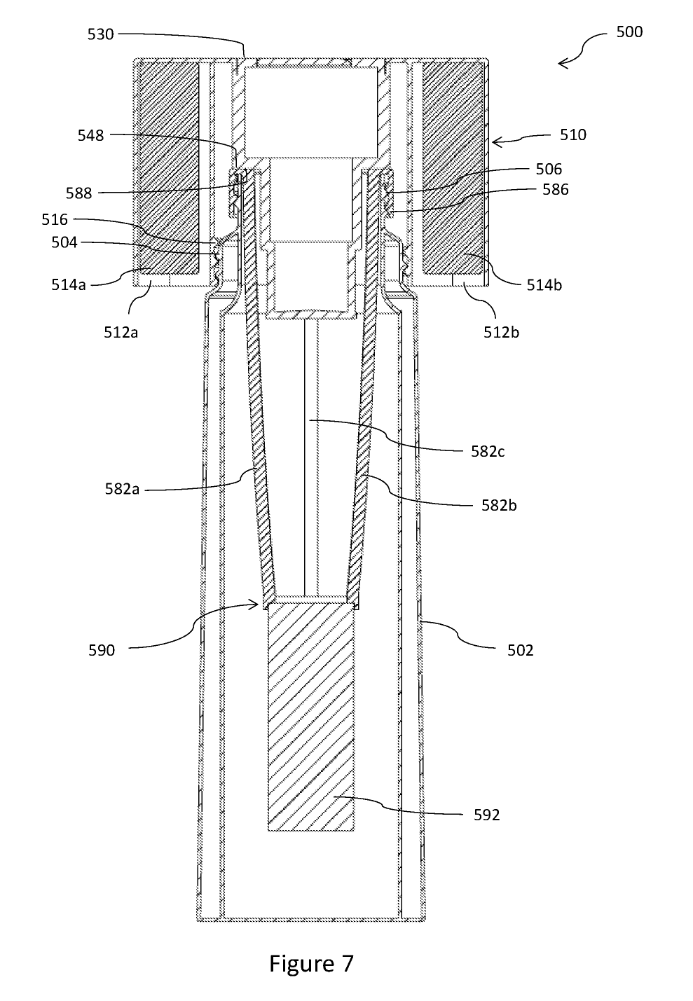

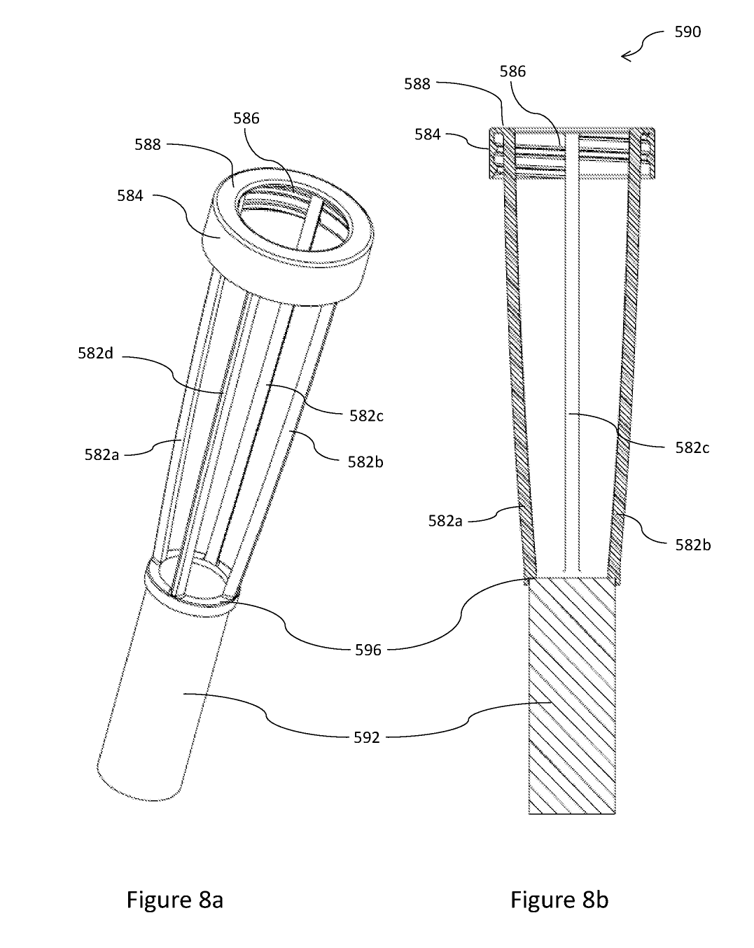

Reference is now made to FIGS. 5-8b, disclosing an embodiment of portable liquid heating apparatus 500, adapted for attachment to liquid containers with at least two distinct screw thread regions. FIG. 5 constitutes a view in perspective of the portable liquid heating apparatus 500, attached to vacuum flask 502, in accordance with some embodiments. FIGS. 6a and 6b constitute a full-blown cross-sectional view and a perspective view, respectively, of portable liquid heating apparatus 500, adapted for a vacuum flask 502. FIG. 7 constitutes a cross-sectional view of portable liquid heating apparatus 500. In accordance with some embodiments, portable liquid heating apparatus 500 comprises heating module 590 and cap 510. FIGS. 8a and 8b constitute a view in perspective and a cross-sectional view, respectively, of the heating module 590. In accordance with some embodiments, heating module 590 comprises heating body 592, top ring 584, and an elongated extension. In accordance with some embodiments, cap 510 comprises top surface 534, cap inner screw thread 516, cap electrically conductive portion 548, at least one power source housing (see four power source housings 512a-d in FIGS. 6a-6b) and control circuitry (not shown). In accordance with some embodiments, heating body 592 comprises heating body outer peripheral surface 594, and proximal portion 596. In accordance with some embodiments, top ring 584 comprises ring inner screw thread 586, and ring electrically conductive portion 588. In accordance with some embodiments, the elongated extension is extending from proximal end 596 of heating body 592 to top ring 584. In accordance with some embodiments, ring inner screw thread 586 is configured to match first complementary screw thread 506 of flask 502, in a manner that attaches heating module 590 to flask 502 so that the heating body 594 is immersed in fluid contained within flask 502. In accordance with some embodiments, cap inner screw thread 516 is configured to match second complementary screw thread 504 of flask 502, in a manner that allows a reliable watertight seal to be achieved between cap 510 and flask 502.

In accordance with some embodiments, the elongated extension comprises at least one extension arm (see four extension arms 582a-d in FIG. 8a).

In accordance with some embodiments, heating body 592 is configured to be partially or fully immersed within a liquid container. In accordance with some embodiments, the liquid is a liquid beverage comprising any one or more of coffee, tea, chocolate drink, milk, water and soups, and the liquid container is a beverage container, such as, a vacuum flask, an urn and a traveler's mug. The length of heating module 590 is preferably chosen to correspond to the depth of the liquid container. The length of extension arms 582a-d is preferably chosen to prevent the human hand from coming in direct contact with heating body 592 once heating module 590 is screwed to flask 502.

The control circuitry is operably associated with heating body 592 for supplying power to heating body 592 and for electively heating the liquid that heating body 592 is immersed in to a selected temperature, or for regulating the heating of heating body 592 to maintain the liquid at a selected temperature.

In accordance with some embodiments, the at least one power source housing 512a-d is configured to house at least one disposable power source.

In accordance with some embodiments, the at least one disposable powers source is a rechargeable power source (see four rechargeable powers sources 514a-d in FIGS. 6a-6b).

In accordance with some embodiments, cap 510 further comprises a socket for a power charging cable (not shown). The power charging cable, when connected to the socket and electrically connected to an external power source (not shown), is configured to either supply power to recharge the rechargeable power source 514a-d, to supply power directly to the control circuitry and heating body 592, or both.

In accordance with some embodiments, the socket comprises a USB charging port configured for receiving a USB cable (not shown). The USB cable, when connected to the USB charging port, serves as a power charging cable in a similar manner described hereinabove.

In accordance with some embodiments, cap 510 further comprises a receiver unit (not shown) configured for receiving energy from an external base unit (not shown) via an inductive magnetic field, wherein the at least one rechargeable power source is capable of being inductively powered and/or charged by the receiver unit.

In accordance with some embodiments, cap 510 further comprises an outgoing socket (not shown), configured to a charging cable to transmit power from the at least one disposable power source to an external device thereby charging said external device. In accordance with some embodiments, the external device includes, but is not limited to, a mobile phone, a mobile watch, a tablet or a laptop. In accordance with some embodiments, the outgoing socket comprises a USB outgoing port configured for receiving a USB cable (not shown). The USB cable, when connected to the USB outgoing port, serves as a charging cable configured to transmit power to the external device.

In accordance with some embodiments, cap 510 further comprises at least one solar cell or solar panel (not shown), configured to collect solar energy that can be used to supply power for recharging the at least one rechargeable power source 514a-d, to supply power directly to the control circuitry and heating body 592, or both.

In accordance with some embodiments, cap 510 further comprises a pressure relief safety valve (not shown). In accordance with some embodiments, the pressure relief safety valve is configured to provide automatic release of pressure from vacuum flask 502, in the event the pressure rises above a predefined threshold corresponding to a maximum operating level.

In accordance with some embodiments, the maximum operating level is correlates with safety. Thus, a maximum operating level is a safe level.

In accordance with some embodiments, portable liquid heating apparatus 500 of the disclosed technology is a mobile device. In accordance with some embodiments, portable liquid heating apparatus 500 is a compact size mobile device. An operator can carry the apparatus of the disclosed technology and use it for heating liquids in a wide variety of liquid containers as described hereinabove. The apparatus, in accordance with the disclosed technology, can be used by a user at any location, indoors and outdoors.

In accordance with some embodiments, top surface 534 of the cap 510 further comprises spout cover 518 configured to transit between an open and closed position (see FIG. 6b for closed position), wherein in its open position it reveals a pouring spout (not shown) of the type well known in the art.

In accordance with some embodiments, the control circuitry is equipped with an internal switching mechanism (not shown), which is configured to either turn on or turn off power transfer to heating body 592. In accordance with some embodiments, cap 510 further comprises an external On/Off switch (not shown), configured to operate the internal switching mechanism.

In accordance with some embodiments, cap 510 further comprises a temperature increase switch and a temperature decrease switch (not shown), configured to allow an operator of apparatus 500 to select or adjust a pre-set temperature for the liquid, thereby controlling the temperature that heating body 592 should reach and/or maintain. In accordance with some embodiments, temperature increase switch and temperature decrease switch are external switches configured to operate the internal switching mechanism, either directly or according to consequent information processing by the control circuitry.

In accordance with some embodiments, the pre-set temperature value may vary only in a predetermined range of values, such that the operator will not be able to reduce the desired temperature value below a predetermined minimal temperature, and will not be able to increase the pre-set temperature value above a predetermined maximal temperature. In accordance with some embodiments, the predetermined range of values is between 30 and 100 degrees Celsius. In accordance with some embodiments, the predetermined range of values is between 40 and 99 degrees Celsius.

In accordance with some embodiments, cap 510 further comprises a display (not shown), configured to display data corresponding to either the operation of the control circuitry, and/or the status the at least one rechargeable power sources 514a-d. In accordance with some embodiments, the display comprises an LCD screen, or any other type of display screen obvious to a skilled person for displaying numerical figures, textual messages and symbols or icons in digital format.

In accordance with some embodiments, the control circuitry is configured to wirelessly communicate with remote electronic devices, thereby transmitting information regarding the operation of the control circuitry.

In accordance with some embodiments, cap 510 further comprises an auditory signal generator unit, such as a speaker, configured to generate sound pulses, beeps, tuners or vocal messages to alert the operator when the temperature of the liquid reaches the pre-set temperature value.

In accordance with some embodiments, external On/Off switch, temperature increase switch, temperature decrease switch, or any combination thereof comprise any one of knobs, switches, dials, levers, buttons and touch interfaces.

In accordance with some embodiments, internal switching mechanism is configured to wirelessly communicate with remote electronic devices, thereby receiving external signals or vocal commands to control the internal switching mechanism.

The control circuitry is configured to control a plurality of operations, including but not limited to power transfer from either rechargeable power sources 514a-d or the power supply cable attached to the socket, to heating body 592, and regulation of the amount of such power transfer, thereby regulating the heat output from heating body 592 to the surrounding liquid in its vicinity.

In accordance with some embodiments, internal switching mechanism may further comprise a timer (not shown), configured to activate or deactivate on or more operations, such as, but not limited to, the operation of: the heating body, the display, the auditory signal generator unit, the external On/Off switch, the temperature increase switch, the temperature decrease switch, incoming and outgoing wireless signal transmission, or any combination thereof. In accordance with some embodiments, the timer activates or deactivates the aforementioned operations for predefined time periods, wherein the time periods can be recurring time periods. In accordance with some embodiments, the timer allows periodic power transfer, thereby defining a cycle composed of a first period of time and a second period of time. In the course of each cycle, activation of an operation is allowed during the first period of time and deactivated during the second period of time, said cycle continues in a loop for either one of: a predefined amount of cycles, a predefined operation duration, or a stop signal. In accordance with some embodiments, the timer is configured to cease its operation when receiving a stop signal. In accordance with some embodiments, the stop signal is transmitted from an external device via wireless communication. In accordance with some embodiments, the timer comprises a spring-operated mechanical mechanism, an electrical timing mechanism or any other mechanism known in the art.

When ring inner screw thread 586 is screwed onto first complementary screw thread 506 of flask 502, and cap inner screw thread 516 is screwed onto second complementary screw thread 504 of flask 502, ring electrically conductive portion 588 and cap electrically conductive portion 548 are in direct contact with one another (see FIG. 7), thus closing an electrical circuit (not shown) of the control circuitry. Closure of the electrical circuit is required to allow power transfer from the at least one rechargeable power source 514a-d or the power supply cable, to heating body 592, meaning that screwing both heating module 590 and cap 510 to flask 502 are preliminary mandatory conditions for heat initiation of the heating body 592.

In accordance with some embodiments, the closure of the electrical circuit as defined hereinabove is essential for the functioning of the control circuitry as well, meaning that all other components that require electrical power, such as the display, switches, or sensors are not operable, in a similar manner, as long as the ring electrically conductive portion 588 and the cap electrically conductive portion 548 are not in contact.

In accordance with some embodiments, the portable liquid heating apparatus 500 further comprises a cap-locking mechanism (not shown), configured to lock cap 510 to heating module 590 once the former is screwed to the latter. In accordance with some embodiments, the cap-locking mechanism comprises a mechanical locking mechanism. In accordance with some embodiments, the cap-locking mechanism comprises an electrical mechanism, configured to unlock cap 510 from heating module 590 due to an electrical signal derived from a lock-controlling electrical circuitry (not shown). In accordance with some embodiments, the signal is generated as a result of an operation of an external switch (not shown) of the portable liquid heating apparatus 500. In accordance with some embodiments, the signal is wirelessly transmitted from an external device. In accordance with some embodiments, the signal is generated only upon supplying a predetermined password, either via communication means embedded on portable liquid heating apparatus 500, such as a keyboard or a touch-screen, or via an external device wirelessly transmitting said signal upon password confirmation.

In accordance with some embodiments, the control circuitry further comprises at least one gyro sensor (not shown), configured to sense angular orientation of the portable liquid heating apparatus 500, such as, but not limited to, horizontal or vertical orientations. In accordance with some embodiments, the control circuitry is configured to control a plurality of operations. In accordance with some embodiments, at least one of the plurality of operations including heating by the heating body, is deactivated in certain predetermined orientations, such as a horizontal of a vertical “upside-down” orientation. In accordance with some embodiments, the cap-locking mechanism is configured to lock cap 510 to heating module 590 when portable liquid heating apparatus 500 is in a vertical “upside-down” orientation, the lock being released when the apparatus is no longer in said vertical “upside-down” orientation.

In accordance with some embodiments, switching the On/Off switch to On state is a mandatory, but not necessarily sufficient, condition for the control circuitry to allow power supply or regulate the amount of power supplied to the heating body 592, thereby activating it. Switching the On/Off switch to Off state is a mandatory and sufficient condition for the control circuitry to stop or prevent initiation of the power supply to heating body 592, thereby deactivating it.

In accordance with some embodiments, a temperature sensor (not shown), which is electrically connected to the control circuitry, is configured to measure the temperature of the liquid surrounding heating body 592. Temperature sensor may comprise any one or more of a thermistor, a thermometer, and an IR sensor.

In accordance with some embodiments, a plurality of temperature sensors are located at different levels along heating module 590 to provide data regarding liquid temperature at different height levels within flask 502.

In accordance with some embodiments, the one or more temperature sensors are housed in a first protective cover tube (not shown).

In accordance with some embodiments, the first protective cover tube is attached to heating body 592.

In accordance with some embodiments, the first protective cover tube is attached to the at least one extension arm 582a-d.

In accordance with some embodiments, the pre-set temperature level set by usage of temperature increase switch and temperature decrease switch is compared in real-time to the liquid temperature as measured by either a single temperature sensor or an averaged value from the measurements of multiple such temperature sensors, so that a measured temperature which is lower than the pre-set temperature is a mandatory, but not necessarily sufficient, condition for the control circuitry to allow power supply or regulate the amount of power supplied to heating body 592, and a measured temperature which is equal to or higher than the pre-set temperature is a mandatory and sufficient condition for the control circuitry to stop or prevent initiation of the power supply to heating body 592, thereby deactivating it.

In accordance with some embodiments, a liquid-level sensor (not shown), which is electrically connected to the control circuitry, is configured to measure the level of the liquid surrounding heating body 592.

In accordance with some embodiments, the liquid-level sensor is housed in a second protective cover tube (not shown).

In accordance with some embodiments, the second protective cover tube is attached to heating body 592.

In accordance with some embodiments, the second protective cover tube is attached to the at least one extension arms 582a-d.

In accordance with some embodiments, the liquid level measured by the liquid-level sensor is compared to a predetermined minimum level threshold, such that a measured liquid level above the predetermined minimum level threshold is a mandatory, but not necessarily sufficient, condition for the control circuitry to allow power supply to heating body 592. In accordance with some embodiments, a measured liquid level which is equal to or lower than the predetermined minimum level threshold is a mandatory and sufficient condition for the control circuitry to stop or prevent initiation of the power supply to heating body 592, thereby deactivating it.

In accordance with some embodiments, the control circuitry is further configured to execute an algorithm based on at least one input supplied by the operator and at least one input measured by the sensors of the apparatus 500. Inputs supplied by the operator include, but are not limited to, expected outdoor duration (e.g. through communication means embedded on the apparatus, or wireless data transmission from an external device). Inputs measured by the sensors of the apparatus 500 include, but are not limited to: current power level of the at least one disposable power source, current liquid temperature, and current liquid level (which, combined with predetermined or entered data regarding container dimensions, can provide dimensions of fluid volume). In accordance with some embodiments, the output of the algorithm is an indicator of the expected liquid heating temperature, either as an absolute value or as a function of time. In accordance with some embodiments, the output is displayed on the display of the apparatus, or transmitted wirelessly to an external device (e.g. a mobile phone).

In accordance with some embodiments, portable liquid heating apparatus 500 further comprises a heat-insulating sleeve (not shown), having an inner sleeve surface (not shown) formed to conform to the outer surface of heating body 592, such that the inner sleeve surface is in contact with heating body outer surface 594, while conforming simultaneously the shape of any other elements attached to heating body 592, such as the first protective cover tube and the second protective cover tube.

In accordance with some embodiments, the heat insulating sleeve is made of materials with very low thermal conductivity. In accordance with some embodiments, the thermal insulation properties of the heat-insulating sleeve ensure that fully heated heating body 592, as well as heated liquid surrounding said sleeve, do not result in a heating the sleeve to a temperature higher than ambient or room temperature. In accordance with some embodiments, the heat-insulating sleeve comprises a flexible heat-insulating material. In accordance with some embodiments, the heat-insulating sleeve comprises silicon.

In accordance with some embodiments, the heat-insulating sleeve further comprises a plurality of apertures (not shown), configured to allow liquid to be in direct contact with heating body 592, yet configured to prevent direct contact of any human organ with heating body 592. This configuration is advantageous for preventing the majority of heat generated by heating body 592 from being reachable to an operator's hand, for example, during voluntary removal of heating module 590 from vacuum flask 502, while not compromising the main function of the apparatus 500, namely conducting direct heat to the surrounding liquid.

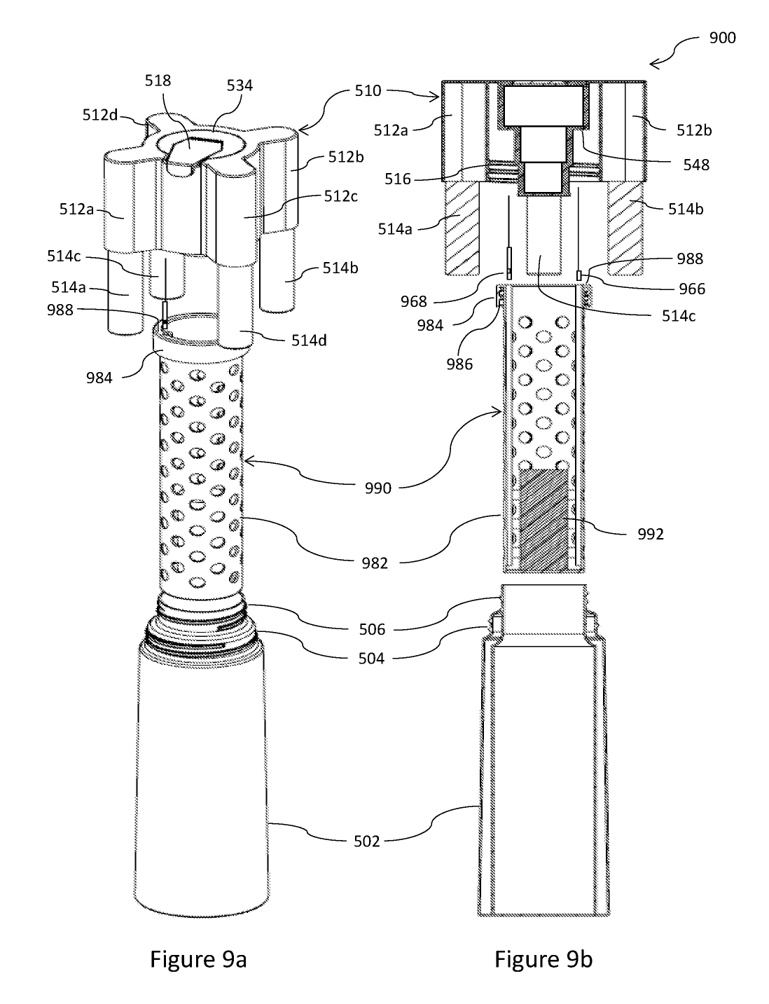

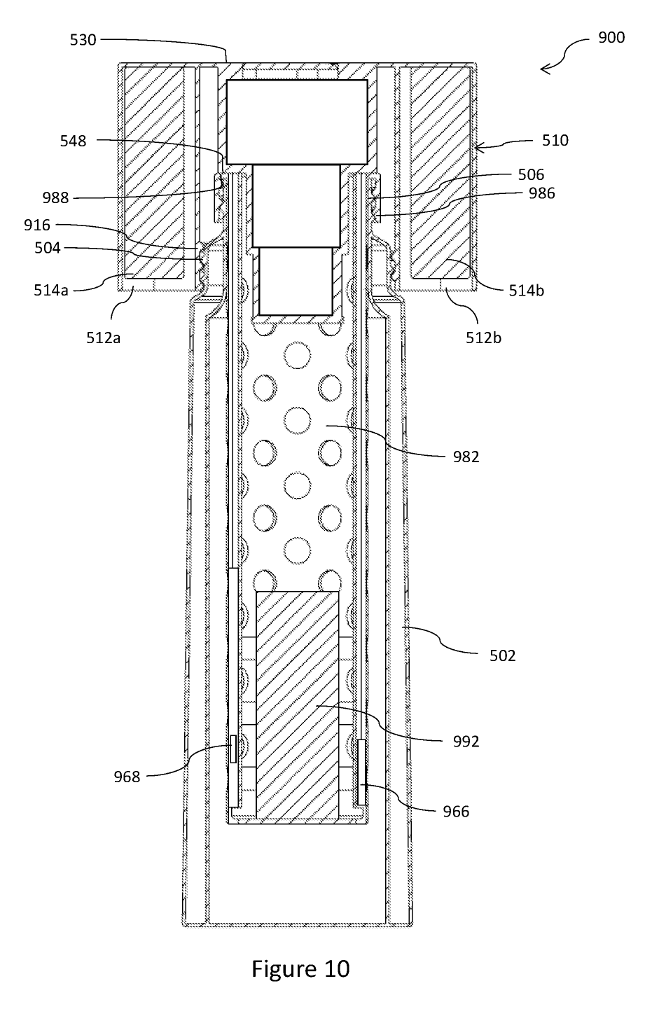

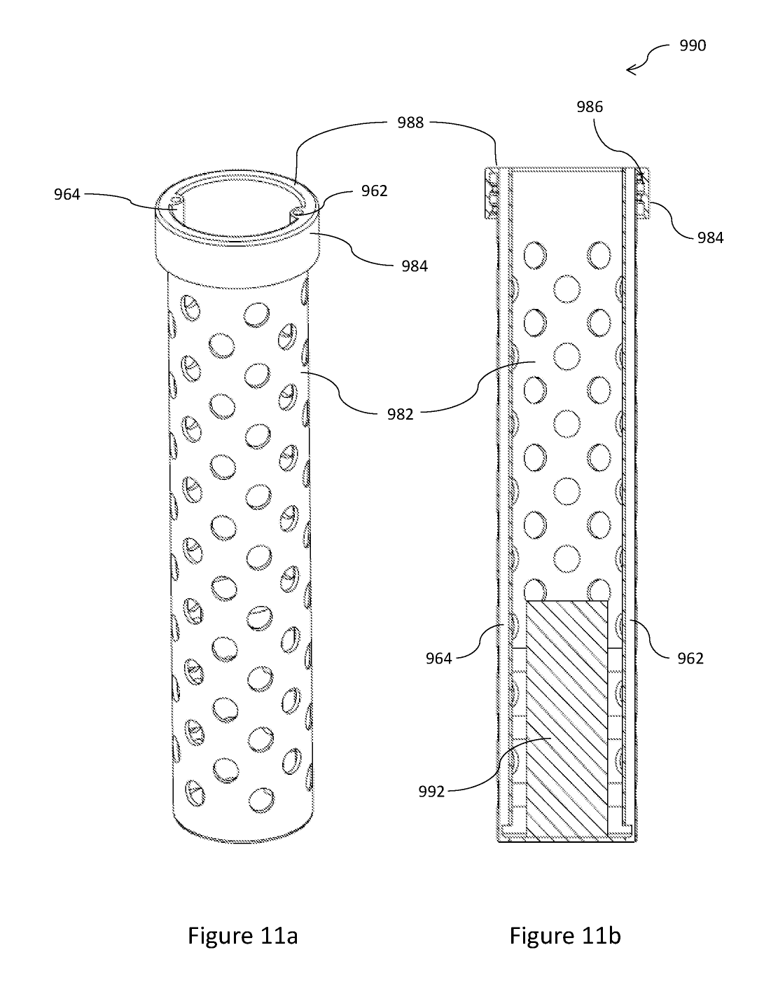

Reference is now made to FIGS. 9a-11b, disclosing another embodiment of portable liquid heating apparatus 900, comprising heating module 990. FIGS. 9a and 9b constitute a full-blown view in perspective and a cross-sectional view, respectively, of portable liquid heating apparatus 900, adapted for vacuum flask 502. FIG. 10 constitutes a cross-sectional view of portable liquid heating apparatus 900. FIGS. 11a and 11b constitute a view in perspective and a cross-sectional view, respectively, of heating module 990. In accordance with some embodiments, heating module 990 comprises heating body 992, top ring 984, and elongated extension 982. In accordance with some embodiments, heating body 992 comprises heating body outer peripheral surface 994. In accordance with some embodiments, top ring 984 comprises ring inner screw thread 986, and ring electrically conductive portion 988. In accordance with some embodiments, elongated extension 982 is extending from proximal end 596 of heating body 592 to top ring 584. In accordance with some embodiments, ring inner screw thread 586 is configured to match first complementary screw thread 506 of flask 502, in a manner that attaches heating module 590 to flask 502 so that heating body 594 is immersed in fluid contained within flask 502.

In accordance with some embodiments, elongated extension 982 comprises a cylindrical cross-section. In accordance with some embodiments, elongated extension 982 further comprises a plurality of apertures (not numbered), which allow the fluid to pass through to and from the space between heating body 992 and elongated extension 984.

The control circuitry of portable liquid heating apparatus 900 is similar in function and connectivity to the control circuitry in portable liquid heating apparatus 500, except that it is operably associated with heating body 992 (and not with heating body 592).

When ring inner screw thread 986 is screwed onto first complementary screw thread 506 of flask 502, and cap inner screw thread 516 is screwed onto second complementary screw thread 504 of flask 502, ring electrically conductive portion 988 and cap electrically conductive portion 548 are in direct contact with one another (see FIG. 10), thus closing an electrical circuit (not shown) of the control circuitry. Closure of the electrical circuit is required to allow power transfer from the at least one rechargeable power source 514a-d to heating body 992, meaning that screwing both heating module 990 and cap 510 to flask 502 are preliminary mandatory conditions for heat initiation of the heating body 992.

In accordance with some embodiments, closure of the electrical circuit as defined hereinabove is essential for the functioning of the control circuitry as well, meaning that all other components that require electrical power, such as the display, switches, or sensors are not operable, in a similar manner, as long as ring electrically conductive portion 988 and cap electrically conductive portion 548 are not in contact.

In accordance with some embodiments, heating module 990 further comprises first protective cover tube 962, configured to house one or more temperature sensors 966. Both first protective cover tube 926 and the at least one temperature sensors 966 are configured to function in a similar manner to that described for portable liquid heating apparatus 500 hereinabove.

In accordance with some embodiments, heating module 590 further comprises second protective cover tube 964, configured to house liquid-level sensor 968. Both second protective cover tube 964 and liquid-level sensor 968 are configured to function in a similar manner to that described for portable liquid heating apparatus 500 hereinabove.

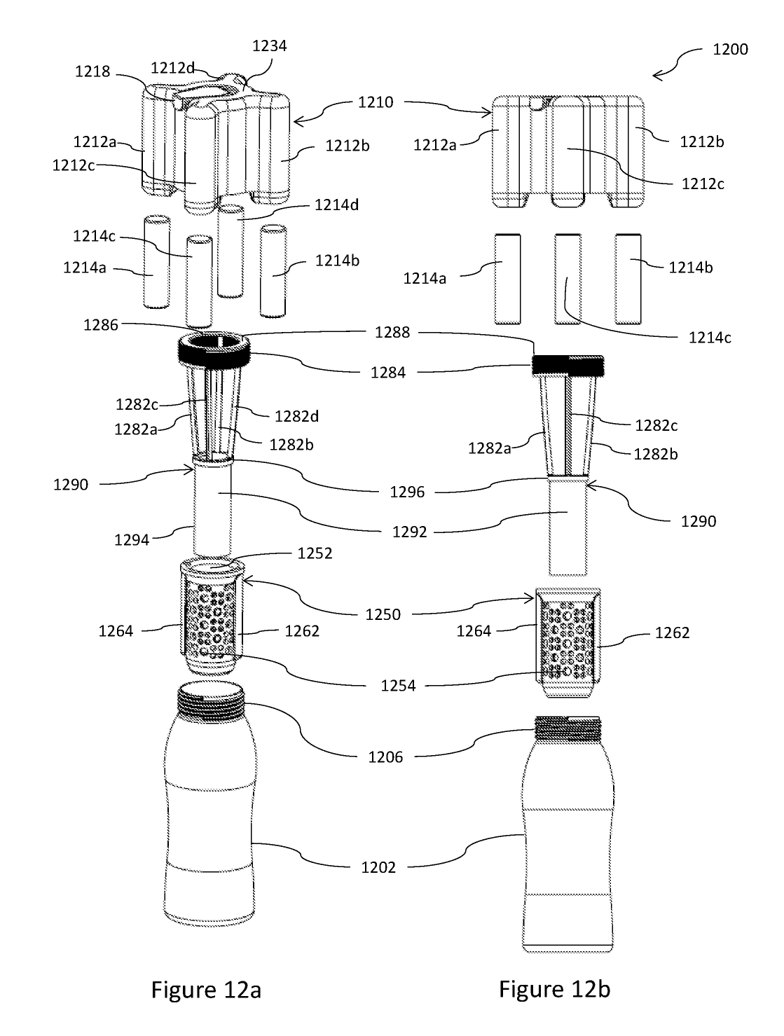

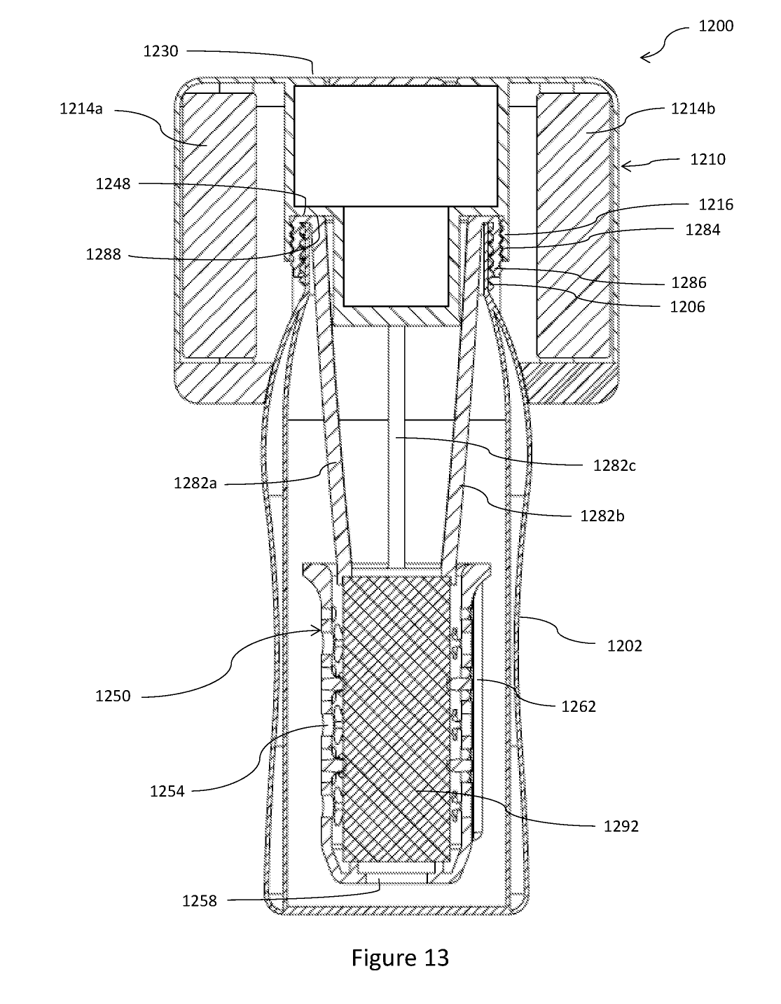

Reference is now made to FIGS. 12a-13, disclosing yet another embodiment of portable liquid heating apparatus 1200, adapted for attachment to liquid containers with at least one screw thread region. FIGS. 12a and 12b constitute a full-blown view in perspective and a side-view, respectively, of portable liquid heating apparatus 1200, adapted for travel mug 1202. FIG. 13 constitutes a cross-sectional view of portable liquid heating apparatus 1200. In accordance with some embodiments, portable liquid heating apparatus 1200 comprises heating module 1290 and cap 1210. In accordance with some embodiments, heating module 1290 comprises heating body 1292, top ring 1284, and an elongated extension. In accordance with some embodiments, cap 1210 comprises top surface 1234, cap inner screw thread 1216, cap electrically conductive portion 1248, at least one power source housing (see four power source housings 1212a-d in FIGS. 12a-12b) and control circuitry (not shown). In accordance with some embodiments, heating body 1292 comprises heating body outer peripheral surface 1294 and proximal portion 1296. In accordance with some embodiments, top ring 1284 comprises ring inner screw thread 1286, ring outer screw thread 1285 and ring electrically conductive portion 1288. In accordance with some embodiments, the elongated extension is extending from proximal end 1296 of heating body 1292 to top ring 1284. In accordance with some embodiments, ring inner screw thread 1286 is configured to match first complementary screw thread 1206 of travel mug 1202, in a manner that attaches heating module 1290 to travel mug 1202 so that heating body 1294 is immersed in fluid contained within travel mug 1202. In accordance with some embodiments, cap inner screw thread 1216 is configured to match ring outer screw thread 1285, in a manner that allows a reliable watertight seal to be achieved between cap 1210 and travel mug 1202 when both heating module 1290 is screwed to travel mug 1202 and cap 1210 is screwed to heating module 1290.

In accordance with some embodiments, the elongated extension comprises at least one extension arm (see four extension arms 1282a-d in FIG. 12a).

In accordance with some embodiments, heating body 1292 is configured to be partially or fully immersed within a liquid container. In accordance with some embodiments, the liquid is a liquid beverage comprising any one or more of coffee, tea, chocolate drink, water and soup, and the liquid container is a beverage container, such as, a vacuum flask, an urn and a traveler's mug. The length of heating module 1290 is preferably chosen to correspond to the depth of the liquid container. The length of extension arms 1282a-d is preferably chosen to prevent the human hand from coming in direct contact with heating body 1292 once heating module 1290 is screwed to travel mug 1202.

The control circuitry is operably associated with heating body 1292 for supplying power to heating body 1292 and for electively heating the liquid that heating body 1292 is immersed in to a selected temperature, or for regulating the heating of heating body 1292 to maintain the liquid at a selected temperature.

In accordance with some embodiments, the at least one power source housing 1212a-d is configured to house at least one disposable power source.

In accordance with some embodiments, the at least one disposable powers source is a rechargeable power source (see four rechargeable powers sources 1214a-d in FIGS. 12a-12b).

In accordance with some embodiments, cap 1210 further comprises a socket for a power charging cable (not shown). The power charging cable, when connected to the socket and electrically connected to an external power source (not shown), is configured to either supply power to recharge rechargeable power source 1214a-d, to supply power directly to the control circuitry and heating body 1292, or both.

In accordance with some embodiments, the socket comprises a USB charging port configured for receiving a USB cable (not shown). The USB cable, when connected to the USB charging port, serves as a power charging cable in a similar manner described hereinabove.

In accordance with some embodiments, cap 1210 further comprises a receiver unit (not shown) configured for receiving energy from an external base unit (not shown) via an inductive magnetic field, wherein the at least one rechargeable power source is capable of being inductively powered and/or charged by the receiver unit.

In accordance with some embodiments, cap 1210 further comprises an outgoing socket (not shown), configured to a charging cable to transmit power from the at least one disposable power source to an external device thereby charging said external device. In accordance with some embodiments, the external device includes, but is not limited to, a mobile phone, a mobile watch, a tablet or a laptop. In accordance with some embodiments, the outgoing socket comprises a USB outgoing port configured for receiving a USB cable (not shown). The USB cable, when connected to the USB outgoing port, serves as a charging cable configured to transmit power to the external device.

In accordance with some embodiments, cap 1210 further comprises at least one solar cell or solar panel (not shown), configured to collect solar energy that can be used to supply power for recharging the at least one rechargeable power source 1214a-d, to supply power directly to the control circuitry and heating body 1292, or both.

In accordance with some embodiments, cap further comprises a pressure relief safety valve (not shown). In accordance with some embodiments, the pressure relief safety valve is configured to provide automatic release of pressure from travel mug 1202 in the event the pressure rises above a predefined threshold corresponding to a maximum operating level.

In accordance with some embodiments, portable liquid heating apparatus 1200 of the disclosed technology is a mobile device. In accordance with some embodiments, portable liquid heating apparatus 1200 is a compact size mobile device. An operator can carry the apparatus of the disclosed technology and use it for heating liquids in a wide variety of liquid containers as described hereinabove. The apparatus, in accordance with the disclosed technology, can be used by a user at any location, indoors and outdoors.

In accordance with some embodiments, top surface 1234 of cap 1210 further comprises spout cover 1218 configured to transit between an open and closed position (see FIG. 12a for closed position), wherein in its open position it reveals a pouring spout (not shown) of the type well known in the art.

In accordance with some embodiments, the control circuitry is equipped with an internal switching mechanism (not shown), which is configured to either turn on or turn off power transfer to heating body 1292. In accordance with some embodiments, cap 1210 further comprises an external On/Off switch (not shown), configured to operate the internal switching mechanism.

In accordance with some embodiments, cap 1210 further comprises a temperature increase switch and a temperature decrease switch (not shown), configured to allow an operator of apparatus 1200 to select or adjust a pre-set temperature for the liquid, thereby controlling the temperature that heating body 1292 should maintain. In accordance with some embodiments, the temperature increase switch and the temperature decrease switch are external switches configured to operate the internal switching mechanism, either directly or according to consequent information processing by the control circuitry.

In accordance with some embodiments, the pre-set temperature value may vary only in a predetermined range of values, such that the operator will not be able to reduce the desired temperature value below a predetermined minimal temperature, and will not be able to increase the pre-set temperature value above a predetermined maximal temperature. In accordance with some embodiments, the predetermined range of values is between 30 and 100 degrees Celsius. In accordance with some embodiments, the predetermined range of values is between 40 and 99 degrees Celsius.

In accordance with some embodiments, cap 1210 further comprises a display (not shown), configured to display data corresponding to either the operation of the control circuitry, and/or the status the at least one rechargeable power sources 1214a-c. In accordance with some embodiments, the display comprises an LCD screen, or any other type of display screen obvious to a skilled person for displaying numerical figures, textual messages and symbols or icons in digital format.

In accordance with some embodiments, the control circuitry is configured to wirelessly communicate with remote electronic devices, thereby transmitting information regarding the operation of the control circuitry.

In accordance with some embodiments, cap 1210 further comprises an auditory signal generator unit, such as a speaker, configured to generate sound pulses, beeps, tuners or vocal messages to alert the operator when the temperature of the liquid reaches the pre-set temperature value.

In accordance with some embodiments, the external On/Off switch, the temperature increase switch, the temperature decrease switch, or any combination thereof comprise any one or more of knobs, switches, dials, levers, buttons and touch interfaces.

In accordance with some embodiments, internal switching mechanism is configured to wirelessly communicate with remote electronic devices, thereby receiving external signals or vocal commands to control the internal switching mechanism.

The control circuitry is configured to control a plurality of operations, including but not limited to power transfer from either rechargeable power sources 1214a-d or the power supply cable attached to the socket, to heating body 1292, and regulation of the amount of such power transfer, thereby regulating the heat output from heating body 1292 to the surrounding liquid in its vicinity.

When ring inner screw thread 1286 is screwed onto first complementary screw thread 1206 of travel mug 1202, and cap inner screw thread 1216 is screwed onto ring outer screw thread 1285, ring electrically conductive portion 1288 and cap electrically conductive portion 1248 are in direct contact with one another (see FIG. 13), thus closing an electrical circuit (not shown) of the control circuitry. Closure of the electrical circuit is required to allow power transfer from the at least one rechargeable power source 1214a-d or the power supply cable, to heating body 1292, meaning that screwing both heating module 1290 to travel mug 1202 and cap 1210 to heating module 1290 are preliminary mandatory conditions for heat initiation of heating body 1292.

In accordance with some embodiments, the closure of the electrical circuit as defined hereinabove is essential for the functioning of the control circuitry as well, meaning that all other components that require electrical power, such as the display, switches, or sensors are not operable, in a similar manner, as long as ring electrically conductive portion 1288 and cap electrically conductive portion 1248 are not in contact.

In accordance with some embodiments, switching the On/Off switch to On state is a mandatory, but not necessarily sufficient, condition for the control circuitry to allow power supply or regulate the amount of power supplied to heating body 1292, thereby activating it. Switching the On/Off switch to Off state is a mandatory and sufficient condition for the control circuitry to stop or prevent initiation of power supply to heating body 592, thereby deactivating it.

In accordance with some embodiments, a temperature sensor (not shown), which is electrically connected to the control circuitry, is configured to measure the temperature of the liquid surrounding heating body 1292. The temperature sensor may comprise any one or more of a thermistor, a thermometer, and an IR sensor.

In accordance with some embodiments, a plurality of temperature sensors are located at different levels along heating module 1290 to provide data regarding liquid temperature at different height levels within travel mug 1202.

In accordance with some embodiments, the one or more temperature sensors are housed in first protective cover tube 1262.

In accordance with some embodiments, first protective cover tube 1262 is attached to heating body 1292.

In accordance with some embodiments, first protective cover tube 1262 is attached to the at least one extension arm 1282a-d.

In accordance with some embodiments, the pre-set temperature level set by usage of the temperature increase switch and the temperature decrease switch is compared in real-time to the liquid temperature as measured by either a single temperature sensor or an averaged value from the measurements of multiple such temperature sensors, so that a measured temperature which is lower than the pre-set temperature is a mandatory, but not necessarily sufficient, condition for the control circuitry to allow power supply or regulate the amount of power supplied to heating body 1292, and a measured temperature which is equal to or higher than the pre-set temperature is a mandatory and sufficient condition for the control circuitry to stop or prevent initiation of the power supply to heating body 1292, thereby deactivating it.

In accordance with some embodiments, a liquid-level sensor (not shown), which is electrically connected to the control circuitry, is configured to measure the level of the liquid surrounding heating body 1292.

In accordance with some embodiments, the liquid-level sensor is housed in second protective cover tube 1264.

In accordance with some embodiments, second protective cover tube 1264 is attached to heating body 1292.

In accordance with some embodiments, second protective cover tube 1264 is attached to the at least one extension arms 1282a-d.

In accordance with some embodiments, the liquid level measured by the liquid-level sensor is compared to a predetermined minimum level threshold, such that a measured liquid level above the predetermined minimum level threshold is a mandatory, but not necessarily sufficient, condition for the control circuitry to allow power supply to heating body 1292. In accordance with some embodiments, a measured liquid level which is equal to or lower than the predetermined minimum level threshold is a mandatory and sufficient condition for the control circuitry to stop or prevent initiation of the power supply to heating body 1292, thereby deactivating it.

In accordance with some embodiments, portable liquid heating apparatus 1200 further comprises heat-insulating sleeve 1250, having an inner sleeve surface 1252 formed to conform to the outer surface of heating body 1292, such that inner sleeve surface 1252 is in contact with heating body outer surface 1294, while conforming simultaneously the shape of any other elements attached to heating body 1292, such as first protective cover tube 1262 and second protective cover tube 1264.

In accordance with some embodiments, heat insulating sleeve 1250 is made of materials with very low thermal conductivity. In accordance with some embodiments, the thermal insulation properties of heat-insulating sleeve 1250 ensure that a heated heating body 1292, as well as heated liquid surrounding said sleeve, do not result in heating sleeve 1250 to a temperature higher than ambient or room temperature. In accordance with some embodiments, heat-insulating sleeve 1250 comprises a flexible heat-insulating material. In accordance with some embodiments, heat-insulating sleeve 1250 comprises silicon.

In accordance with some embodiments, heat-insulating sleeve 1250 further comprises a plurality of apertures 1254, configured to allow liquid to be in direct contact with heating body 1292, yet configured to prevent direct contact of any human organ with heating body 1292. This configuration is advantageous for preventing the majority of heat generated by heating body 1292 from being reachable by an operator's hand, for example during voluntary removal of heating module 1290 from vacuum travel mug 1202, while not compromising the main function of apparatus 1200, namely conducting direct heat to the surrounding liquid.

As used herein, the terms “about” or “within the range of” mean in the range of, roughly, or around. In general, the terms “about” or “within the range of” are used to modify a numerical value above and below the stated value by 20%. According to some embodiments, the term “about” or “within the range of” are used to modify a numerical value above and below the stated value by 15% thereof. According to some embodiments, the term “about” or “within the range of” are used to modify a numerical value above and below the stated value by 10% thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. No feature described in the context of an embodiment is to be considered an essential feature of that embodiment, unless explicitly specified as such.

Although the invention is described in conjunction with specific embodiments thereof, it is evident that numerous alternatives, modifications and variations that are apparent to those skilled in the art may exist. It is to be understood that the invention is not necessarily limited in its application to the details of construction and the arrangement of the components and/or methods set forth herein. Other embodiments may be practiced, and an embodiment may be carried out in various ways. Accordingly, the invention embraces all such alternatives, modifications and variations that fall within the scope of the appended claims.

1. A portable liquid heating apparatus, comprising:
(i) a heating body having an outer peripheral surface, the heating body is configured to exert a plurality of operations;
(ii) a heat-insulating sleeve configured to enclose said heating body, said heat-insulating sleeve comprises a plurality of apertures and a proximal end facing the handle; and
(iii) a handle connected to the heating body, comprising:
a) a control circuitry configured to control the plurality of operations;
b) at least one power source housing, configured to house at least one disposable power source, wherein the at least one disposable power source is configured to provide electrical energy to at least one of said control circuitry and said heating body; and
c) at least one internal switching mechanisms configured to activate or deactivate at least one operation of said plurality of operations.

2. The portable liquid heating apparatus of claim 1, wherein said heat-insulating sleeve is flexible.

3. The portable liquid heating apparatus of claim 2, wherein said heat-insulating sleeve comprises silicon.

4. The portable liquid heating apparatus of claim 1, further comprising at least one external switch, configured to control the at least one internal switching mechanisms.

5. The portable liquid heating apparatus of claim 1, further comprising one or more temperature sensors, configured to measure the temperature of liquid surrounding said heating body.

6. The portable liquid heating apparatus of claim 1, wherein the at least one operation is heating.

7. The portable liquid heating apparatus of claim 1, further comprising a display element configured to display at least one of data corresponding to the at least one operation and data corresponding to the power source.

8. The portable liquid heating apparatus of claim 6, further comprising one or more temperature sensors, configured to measure the temperature of liquid surrounding said heating body, wherein the display element displays said.

9. The portable liquid heating apparatus of claim 7, wherein the at least one operation is heating liquid surrounding said heating body to a pre-set temperature value.

10. The portable liquid heating apparatus of claim 9, further comprising at least one switch, wherein the at least one switch is configured to receive from an operator a temperature value, said temperature value is the pre-set temperature value.

11. The portable liquid heating apparatus of claim 1, further comprising at least one liquid level sensor connected to said control circuitry such that said control circuitry is configured to deactivate the heating body when the at least one liquid level sensor senses liquid level below a predetermined threshold.

12. The portable liquid heating apparatus of claim 1, further comprising a timer, wherein the timer is configured to activate or deactivate at least one of said plurality of operations for predetermined time periods.

13. The portable liquid heating apparatus of claim 12, wherein the predetermined time periods comprise a first period of time and a second period of time, and wherein said timer is configured to deactivate the at least one of said plurality of operations during the first period of time and activate the at least one of said plurality of operations during the second period of time, in a recurring manner.

14. The portable liquid heating apparatus of claim 1, wherein the heat-insulating sleeve further comprises at least one sensor compartment, configured to house a sensor.

15. The portable liquid heating apparatus of claim 1, further comprising a stopper extending from any one of the handle, the heat-insulating sleeve and the heating body, wherein said stopper is configured to prevent contact between the handle and liquid upon immersion of the liquid heating apparatus in the liquid.

16. The portable liquid heating apparatus of claim 15, wherein the stopper extends from the proximal end of the heat-insulating sleeve and is configured to prevent or reduce evaporation of liquid upon immersion of the apparatus within a container containing the liquid.

17. The portable liquid heating apparatus of claim 1, wherein said heat-insulating sleeve is reversibly attached to said heating body.

18. The portable liquid heating apparatus of claim 1, further comprising a screw thread region.

19. A portable liquid heating apparatus, comprising:
(i) a heating module, comprising:
a) a heating body having an outer peripheral surface and a proximal portion, the heating body is configured to exert a plurality of operations;
b) a top ring, having a ring inner screw thread and a ring electrically conductive portion; and
c) an elongated extension extending from the proximal portion of the heating body to the top ring.
(ii) a cap comprising:
a) a cap inner screw thread;
b) a cap electrically conductive portion;
c) a control circuitry configured to control the plurality of operations;
d) at least one power source housing, configured to house at least one disposable power source, wherein the at least one disposable power source is configured to provide electrical energy to at least one of said control circuitry and said heating body; and
e) at least one internal switching mechanisms configured to activate or deactivate at least one operation of said plurality of operations,
wherein the cap is configured to close an electrical circuit and conduct electricity to said heating body, through the top ring and elongated extension, when the cap electrically conductive portion is in contact with the ring electrically conductive portion.

20. The portable liquid heating apparatus of claim 19, wherein the at least one internal switching mechanism is configured to automatically activate the at least one operation when the cap electrically conductive portion is in contact with the ring electrically conductive portion.
